(19) United States
(12) Patent Application Publication
(10) Pub. No.: US 2026/0267506 A1
(43) Pub. Date: Sep. 10, 2026

(54) METHOD AND SYSTEM FOR AUTOMATIC DATA PLACEMENT

(71) Applicant: INSTITUT MINES TELECOM, PALAISEAU (FR)

(72) Inventors: Atef SHAAR, PUTEAUX (FR); Nadia BOUKHATEM, PARIS (FR); Hana BACCOUCH, PUTEAUX (FR)

(21) Appl. No.: 19/166,222

(22) PCT Filed: Mar. 15, 2024
(86) PCT No.: PCT/EP2024/057062

§ 371 Date: Oct. 8, 2025

(30) Foreign Application Priority Data
Mar. 17, 2023 (FR) FR2302484

(51) Int. Cl. G06F 3/06

(52) U.S. Cl. CPC G06F 3/0604; G06F 3/0638; G06F 3/0668

(57) ABSTRACT

A method for automatically placing data in a storage system having various types of storage media, according to at least one category of data. The method includes at least the step of classifying the data according to their category. This classification being carried out by an online machine learning technique using collected information relating to said data and being done on the fly.

### TECHNICAL FIELD

The present invention relates to the field of data placement for storage systems, and more particularly relates to a method and a system for automatic data placement which are based on online machine learning.

### PRIOR ART

A data storage system may have various types of storage media. Each medium may have particular characteristics of cost, of speed of access or of storage capacity. These systems may, for example, use, at the same time, solid state drives (SSDs), non-volatile memory express (NVMe), hard disk drives (HDDs), optical drives, magnetic tapes, etc. “Data placement” is understood to mean associating or assigning a datum with/to a storage medium.

In storage systems, the data temperature, which refers to the frequency with which the data are accessed, is often used to distinguish between hot data, which are accessed very frequently, and cold data, which are not very often accessed.

Hot data may, for example, be placed on low-latency storage media such as SSDs and NVMe, which are often expensive. Data classified as cold may be backed up on slower-speed but inexpensive storage media such as HDDs, Blu-ray or magnetic tapes.

Most data storage systems support solutions for migration from one type of access (hot) to another (cold). This leads to the consumption of considerable resources (moving data from one location to another, requiring considerable network and data-processing resources), and requires data control tasks, as well as manual configuration.

Data storage systems use various techniques which allow data to be moved from one storage medium to another (for example from high-cost storage media to low-cost media).

With these techniques, the moving, if automatic, is based on static policies configured by the user, for example the administrator of the system, the customers, etc. An administrator, for example, may define movement policies for each datum or group of data. The policy may include or exclude data of a certain type or based on their age or their size.

Recent predictions relating to stored data volumes forecast a global production of 163 zettabytes per year by 2025 (source IDC). Faced with these colossal volumes of data to be stored, the current trend in the storage industry is to call upon machine learning techniques and artificial intelligence (AI) to develop learning methods which facilitate the automation of management tasks. Today, these techniques are applied for anomaly detection, predictive analysis (capacity forecasting), administration assistance, drive failure detection, virtual machine migration, among others.

In the article by Cheng, Peng, et al. “Optimizing Data Placement on Hierarchical Storage Architecture via Machine Learning”, IFIP International Conference on Network and Parallel Computing, Springer, Cham, 2019., machine learning algorithms are used to carry out optimal data placement based on the characteristics of a series of commands (“workflow”) at input in order to optimize the performance of the system in terms of drive reading/writing. However, this work was developed for Big Data, based on the characteristics of series of commands and aims to optimize the execution time of the tasks and the performance of the system in terms of input/output. The gradient boosting algorithm with the Classification and Regression Tree (CART) method is used to train the prediction/classification model.

The data placement in this publication does not consider the characteristics of the data but those of command series, without taking account of the relocation of the data and uses offline, and not online, learning algorithms.

The authors Kale, R. V., et al. in “A Practicable Machine Learning Solution for Security-Cognizant Data Placement on Cloud Platforms”, in handbook of computer networks and cyber security, Springer, used data placement based on neural networks to ensure the availability of the data in the event of security threats or cyber attacks.

A technique based on neural networks was also used by Ren, J., et al. “Archivist: a machine learning assisted data placement mechanism for hybrid storage systems”, IEEE 37th International Conference on Computer Design (ICCD), to assist data placement and reduce file access latency. Their solution is based on the estimation of the file access model and offline use of neural networks. Such a method cannot detect sudden changes in the classification of the data. Since learning is carried out offline, considerable volumes of data need to be backed up in order to train the algorithms.

Patent application US 2022/0334719 discloses a method which falls within the scope of an object-based data storage system. In this system, a datum (data object) is initially stored in a so-called standard storage space then, based on the characteristics of the datum, the latter is moved secondly to a second (for example, non-frequent) storage space that is more appropriate with regard to these characteristics.

Unlike the invention, the service proposed by patent application US 2022/0334719 does not carry out the appropriate placement of the datum as soon as it enters the storage system and is not based on online learning in order to carry out the data placement.

Furthermore, the system described in patent application US 2022/0334719 uses a set of parameters which requires prior manual configuration.

### SUMMARY OF THE INVENTION

There is a need to improve the methods for automatic data placement, in particular in terms of reducing the cost of storage.

### Automatic Placement Method Based on Learning

The invention aims to address this objective and relates, according to one of its aspects, to a method for automatically placing data in a storage system having various types of storage media, according to at least one category of data, comprising at least the step of classifying the data according to their category, this classification being carried out by an online machine learning technique using collected information relating to said data.

“Data placement” is understood to mean associating or assigning a datum with/to a storage medium.

The invention proposes automatic data placement “on the fly”.

“On the fly” is understood to mean: as soon as the datum enters the system, it is assigned directly to the most appropriate location by virtue of the learning carried out. This is contrary to the known systems which often place the data entering the system in a given (for example frequent) storage space in order to move them a posteriori to another storage space. The learning method ensures that the initial placement of the datum is as optimal as possible in order to avoid future moving of the datum.

The invention proposes automatic data placement based on learning which does not necessarily require a configuration phase; a customer, for example, is not obliged to specify by configuration the classification parameters of their data; by virtue of the learning, the placement is done automatically based on the characteristics of the data and the previously learnt information.

Furthermore, by providing on-the-fly and appropriate placement of the data as soon as they enter the storage system, based both on their characteristics and their previously learnt category, the invention makes it possible to avoid carrying out the relocation of the data, thus offering a reduction in costs in terms of bandwidth and of computing resources contributing to the reduction in storage costs.

Optimizing storage infrastructure costs would allow storage providers to offer services at competitive rates with an improved user experience quality (optimized data access times). Automatic placement, which is done on the fly, offers more flexibility in the sense that the administrator and/or the customer are relieved of manual and time-consuming configuration tasks.

In addition, automatic placement, by making it possible to reduce the relocation costs, makes it possible to improve response times.

Compared to patent application US 2022/0334719, the invention uses online machine learning based on artificial intelligence which makes it possible to make the appropriate placement as soon as the datum enters the storage system. In addition, unlike the system described in that patent application, the invention does not require any prior manual configuration. Artificial intelligence, through online learning, is used to automatically learn the appropriate location for the data entering the storage system and to dynamically adapt to changes in the storage system.

Machine learning makes it possible to avoid relocating (moving) the datum from the standard storage space to the secondary space. The inventive system would most likely have placed the datum directly in the secondary system based on what was previously learnt. The invention may be seen as an additional means to cope with the complexity of storage management systems, complexity accentuated by the variety of types of storage media deployed today, the varied needs (low latency, fast access, high throughput, etc.) for the storage services to offer and the large volumes of data to manage.

The invention is based on a learning method adapted to various changes in the storage system and requires less computing power compared to methods based on neural networks and consumes few storage resources.

### Category of Data

The data may be files.

Preferably, said at least one category of data is defined by the characteristics of said datum, in particular the frequency of access to the data.

By correctly placing the data in the appropriate spaces, frequently accessed data will have fast access times.

In one embodiment, said at least one category of data is the type of storage medium.

In another embodiment, said at least one category of data is a storage service. This may be, for example, online storage, network attached storage (NAS), or software defined storage (SDS).

In another embodiment, said at least one category of data is the storage location.

### Machine Learning Technique

Preferably, the online machine learning technique is based on online decision trees and is in particular chosen from: the online random forest technique, a Hoeffding tree technique and a stochastic gradient tree technique. The online random forest technique is designed to solve multi-class classification problems, making it possible to predict the category to which the data belong.

The online random forest technique has the advantage of consuming few resources at the level of the processor. It also has the advantage of being highly accurate while offering speed of execution compared to other supervised techniques. Furthermore, online random forest is an algorithm that is simple to implement, robust and makes it possible to manage unbalanced data. It can adapt to the class imbalance that may be encountered in a distributed storage system, this ensuring greater accuracy compared to other machine learning models. For example, in two-tier hot/cold distributed storage systems, it is common to have more cold data than hot data. This imbalance between the proportion of hot and cold data can affect the training process of the machine learning model, resulting in biased learning and erroneous predictions.

In addition, the online random forest technique may be made parallel, this making it possible to distribute the computing needs for the construction of the machine learning model between a plurality of nodes, the method according to the invention then being able to operate without affecting the main processes.

Moreover, this technique is interpretable, this meaning that the machine learning model can be used not only for prediction but also to reveal hidden patterns in the data. These patterns may be reported to a data management team to assist with monitoring and with future actions, without requiring significant prior configurations. Additionally, online random forest does not require considerable configurations, as is the case for the gradient boosting method or methods based on neural networks which require a prior configuration step.

The use of other machine learning techniques based on online decision trees is also possible, such as, for example, Hoeffding tree techniques.

The Hoeffding tree classifier and the Hoeffding tree regressor are two other online tree algorithms which may be used within the scope of the method according to the invention. They use the Hoeffding limit to control split decisions and rely on the calculation of the reduction in the variance in the target space to decide between split candidates. For these two techniques, learning is faster but less accurate than online random forest.

The stochastic gradient trees technique may also be used. This is an online algorithm which minimizes a loss function instead of the variance of the target space. It has the advantage of requiring less memory than Hoeffding trees and online random forest; however, it cannot progress in parallel.

### The History and the Characteristics of the Data

Said collected information preferably comprises at least metadata and a history of the datum to be placed.

The history of the datum comprises information about the characteristics of said datum and extracted from the trace files of the system, also called log files. A “log file of the system” is understood to mean a file that contains a history of the events that have occurred on the system.

The metadata may comprise at least the type of the datum, its size and the information about the user.

The machine learning technique preferentially uses the history and the characteristics of the data.

The characteristics of the datum preferably comprise at least the type of the datum, its name, its size, its access path, its access frequency, information about the user.

### Other Steps of the Method

In one embodiment, the method comprises a step prior to the classification, in the learning phase, consisting in preparing the data to be placed by assigning them predefined categories on the basis of the information relating to said data.

The method preferentially comprises detecting a sudden change in category.

The method according to the invention is implemented by computer. “Computer” is understood to mean any electronic system which may comprise a set of multiple machines and which has computer processing capabilities. Conventionally, a computer comprises a processor, a memory, a man-machine interface, for example a keyboard, a mouse or a touch screen, a screen and a communication module, in particular Ethernet, WIFI, Bluetooth® or using a mobile telephony technology, for example a technology operating with the GSM, GPRS, EDGE, LTE or UMTS protocols.

The method may be implemented in the form of software (or a computer program).

### Automatic Placement System

The invention also relates, according to another of its aspects, to a system for automatically placing data in a storage system according to at least one category of data, for implementing the method according to the invention, the placement system comprising a classification module configured to predict the category of data by using an online machine learning technique using information relating to said data.

The system may comprise a data preparation module upstream of the classification module, in the learning phase, configured to prepare the data to be placed by assigning them predefined categories on the basis of the information relating to said data.

The classification module preferentially comprises a sub-module for predicting a sudden change in category.

### BRIEF DESCRIPTION OF THE DRAWINGS

The invention will be able to be better understood on reading the following detailed description of non-limiting exemplary implementations thereof, and on examining the appended drawing, in which:

FIG. 1 schematically shows an example of a system for automatic data placement according to the invention.

### DETAILED DESCRIPTION

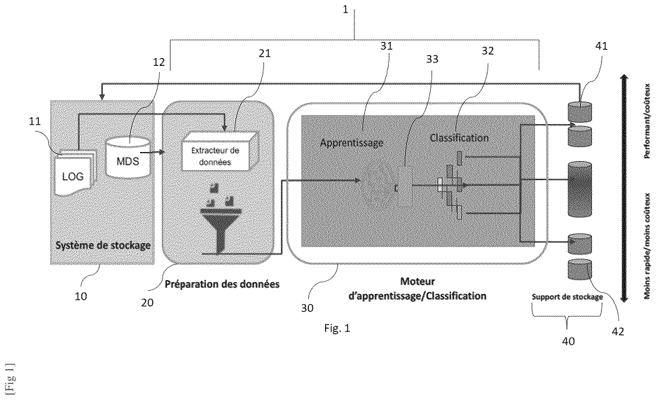

FIG. 1 schematically illustrates an example of a system 1 for automatic data placement according to the invention. This system 1 comprises a data preparation module 20 and a learning and classification module 30.

The data preparation module 20 comprises a data extractor 21 configured to collect information relating to the data to be classified from a storage system 10.

The system 10 may comprise trace files 11 of the system (log files) and characteristics of the data 12 (comprising in particular metadata, for example the type of the datum, its name, its size, its access path, its access frequency, information about the user, etc.). Other information is possible depending on the underlying storage architecture. On the basis of this information, the preparation module 20 assigns predefined categories to the data. For example, the label “cold” is assigned to data that is rarely accessed, and the label “hot” is assigned to data that is frequently requested.

The information about the data and their predefined categories (labels) then goes to the input of the learning and classification module 30. This module comprises a learning engine 31 and a classifier 32, and its main objective is to be able to predict the category of a datum based on its access activity.

The learning engine 31 uses an online machine learning technique, being in the example described the so-called online random forest technique as presented above.

The classifier 32 is configured to predict the data access category based on the output of the learning engine 31.

The learning and classification module 30 may further comprise a sub-module 33 for predicting the stability of the data access model.

The concept of “drift” in machine learning refers to the sudden change in the relationship between the input data and the output of the learning model. In the learning model of the present invention, a drift detection module may be integrated in order to identify sudden changes in data categories.

Such a sub-module 33 would be used, for example, to determine when data suddenly pass from a given category to a different category (in this instance, a datum which was considered little in demand for a long time and which suddenly becomes very much in demand by users). Each datum is then placed in a storage medium 40 according to its predicted category, which may be “cold” or “hot”. “Cold” data are placed in a slower-access and less expensive medium 42 and “hot” data are placed in a high-performance and expensive medium 41.

The result of the automatic placement is returned via a feedback loop to the storage system 10 for updating the log files 11 and the metadata 12, with the aim of improving the accuracy of the storage system 10 and therefore the quality of the machine learning.

Hierarchical Storage Management (HSM) systems, tiering storage, object-based storage systems, file systems, cloud storage or multi-cloud are systems in which this invention may be applied.

The invention may be integrated into cloud or professional data storage software as well as management and monitoring systems for these systems.

It may also be applied, more generally, to any system in which the data must be placed in particular locations provided that these data are characterized by specific attributes. Big Data may be considered to be another application.

Several actors in the storage market may be potential customers for the application of this invention:
cloud and storage service providers;
companies that manage and optimize their own storage infrastructure;
publishers of storage system software, or of storage systems management/monitoring software, that could position themselves as an intermediary and integrate the solution.

The invention is not limited to the exemplary embodiment described above.

Other machine learning techniques and other categories of data are absolutely conceivable.

1. A method for automatically placing data in a storage system having various types of storage media, according to at least one category of data, comprising at least the step of classifying the data according to their category, this classification being carried out by an online machine learning technique using collected information relating to said data and being done on the fly.

2. The method as claimed in claim 1, said collected information comprising at least metadata and a history of the datum to be placed.

3. The method as claimed in claim 1, said at least one category of data being defined by the characteristics of said datum, in particular the frequency of access to the data.

4. The method as claimed in claim 1, said at least one category of data being the type of storage medium.

5. The method as claimed in claim 1, said at least one category of data being a storage service.

6. The method as claimed in claim 1, said at least one category of data being the storage location.

7. The method as claimed in claim 1, the online machine learning technique being based on online decision trees.

8. The method as claimed in claim 8, the online machine learning technique based on online decision trees being the online random forest technique or a Hoeffding tree technique or a stochastic gradient tree technique.

9. The method as claimed in claim 1, the machine learning technique using the history and the characteristics of the data.

10. The method as claimed in claim 1, comprising a step prior to the classification, in the learning phase, consisting in preparing the data to be placed by assigning them predefined categories on the basis of the information relating to said data.

11. The method as claimed in claim 1, comprising detecting a sudden change in category.

12. A system for automatically placing data in a storage system having various types of storage media according to at least one category of data, for implementing the method as claimed in any one of the preceding claims, the placement system comprising a classification module configured to predict the category of data by using an online machine learning technique using information relating to said data.

13. The system as claimed in claim 12, comprising a data preparation module upstream of the classification module, in the learning phase, configured to prepare the data to be placed by assigning them predefined categories on the basis of the information relating to said data.

14. The system as claimed in claim 12, the classification module comprising a sub-module for predicting a sudden change in category.

15. The method as claimed in claim 1, the characteristics of the data comprising at least the type of the datum, its name, Its size, its access path, its access frequency, information about the user
